(19) United States
(12) Patent Application Publication
(10) Pub. No.: US 2005/0068378 A1
(43) Pub. Date: Mar. 31, 2005

(54) Liquid discharge head, manufacturing method thereof, and inkjet recording apparatus

(76) Inventor: Kazuo Sanada, Ashigara-Kami-Gun (JP)

Correspondence Address: BIRCH STEWART KOLASCH & BIRCH, PO BOX 747, FALLS CHURCH, VA, 22040-0747, US

(21) Appl. No.: 10/948,181

(22) Filed: Sep. 24, 2004

(30) Foreign Application Priority Data
Sep. 26, 2003 (JP) 2003-336239

(51) Int. Cl. B41J 2/045

(52) U.S. Cl. 347/68

(57) ABSTRACT

A manufacturing method for a droplet discharge head comprising the steps of: forming a pressure chamber by laminating a discharge port formation plate formed with discharge ports for discharging droplets, a flow channel formation plate for forming the partition walls of the pressure chamber for connecting to the discharge ports, and a vibration plate; forming a concavo-convex structure on the surface of the vibration plate; and forming a piezoelectric body by the aerosol method on the concavo-convex structure of the vibration plate surface, for generating pressure changes in the pressure chamber.

### BACKGROUND OF THE INVENTION

1. Field of the Invention

The present invention relates to a liquid discharge head, manufacturing method thereof, and inkjet recording apparatus, and more specifically to a liquid discharge head, manufacturing method thereof, and inkjet recording apparatus wherein a portion of the pressure chamber that is connected to a discharge port for discharging droplets is composed of a vibration plate, a piezoelectric element is provided to this vibration plate, the vibration plate is deformed by the displacement of the piezoelectric element, and droplets inside the pressure chamber are discharged from the discharge port by changing the volume of the pressure chamber.

2. Description of the Related Art

In prior art, inkjet heads and other droplet discharge heads that supply ink to a recording head, for example, and discharge ink as small ink droplets from the nozzles in the recording head toward recording paper to perform recording, are known.

Such a conventional droplet discharge head is shown in FIG. 5. FIG. 5 is a cross-sectional diagram showing the principal components of a droplet discharge head. As shown in FIG. 5, the droplet discharge head 100 is principally composed of a nozzle plate 104 in which a nozzle 102, which is a discharge port for discharging droplets, is formed, a pressure chamber 110 formed by partition walls 106 and a vibration plate 118, and a piezoelectric element 112 provided to the vibration plate 118. The pressure chamber 110 is connected to the nozzle 102, and the structure is configured so that liquid is fed from the liquid supply channel (not depicted) to the pressure chamber 110.

When a voltage commensurate with an image signal is applied by a drive device (not depicted) through an electrode (not depicted) disposed above and below the piezoelectric element 112, the piezoelectric element 112 is displaced, the vibration plate 118 is thereby deformed, and a droplet is discharged from the nozzle 102 due to the change in the volume of the pressure chamber 110.

Conventionally, a liquid discharge head 100 is manufactured by a method in which a nozzle plate 104 provided with a nozzle 102, a flow channel plate 107 provided with portions that serve as the partition walls 106 of the pressure chamber 110, a vibration plate 118, and a piezoelectric element 112 are bonded and laminated using an adhesive. A variety of other manufacturing methods are also known in the art.

Examples of known methods include those in which an actuator unit formed by laminating and integrally baking plates and other components provided with piezoelectric elements, vibration plates, and pressure chambers is bonded with a flow channel unit composed of plates and other components provided with ink supply channels or nozzles by using an adhesive (refer to Japanese Patent Application Publication No. 7-156398, for example); and those that entail forming, overlaying, and laminating a layer of glass film on the surface of each plate, softening and fusing the glass layers on the surface of each plate, and tightly bonding these together (refer to Japanese Patent Application Publication No. 2003-63017, for example).

However, these approaches have a drawback in that piezoelectric elements are very thin, so these may potentially crack when overlaid, subjected to pressure, and laminated, and it is difficult to obtain a uniform film thickness over a wide range, so the aerosol method is being considered as a method for forming a piezoelectric element. The aerosol method is referred to as the aerosol gas deposition method or simply the gas deposition method, the powder method, or the like. This method entails blowing argon or another carrier gas onto PZT (lead zirconate titanate Pb(Zr, Ti)O₃) in an ultrafine particulate state, spraying and depositing at a high speed the fine particles of PZT picked up by this gas through a spray nozzle with the carrier gas, and forming a film with a heating treatment. This type of aerosol method entails directly depositing fine particles to the target and baking the particles to create a film. A broad range of film thicknesses can be obtained.

In other words, when a piezoelectric element is formed on a vibration plate with the aerosol method, submicron piezoelectric particles are shot at high speeds toward a heated vibration plate, and a heat treatment is thereafter carried out at about 600° C. When this process is completed, the deposited piezoelectric particles form a perovskite structure as a result, and the structure shows a reverse piezoelectric effect as a whole, in the same manner as a so-called bulk piezoelectric body. Formation of a piezoelectric body on a vibration plate entails applying a mask with an opening at the pressure chamber position, depositing powder, depositing an electrode by sputtering or the like, and thereafter dissolving away the mask.

However, the heat treatment is performed at about 600° C., so when an attempt is made to form a piezoelectric element with the aerosol method on a plate laminated with a conventional adhesive, the adhesive cannot withstand the temperature of the heat treatment, may melt and block the liquid flow channel and the discharge port, and may be an obstacle in the normal driving of the droplet discharge head. In view of the above, when using the aerosol method, it is possible to consider an approach whereby a piezoelectric element is separately formed by the aerosol method on a vibration plate separate from a laminate produced by laminating flow channel plates and other plates other than the vibration plate with an adhesive, and thereafter bonding the vibration plate on which the piezoelectric element is formed by the aerosol method with the laminated plates.

Alternatively, as shown in FIG. 6, it is possible to form a structure without the use of an adhesive by etching the silicon substrate 122 to form a pressure chamber 124 and a vibration plate 126, bonding the chamber and the plate by means of anodic bonding with a nozzle plate 130 on which a nozzle 128 is formed, and a piezoelectric element 132 can be formed on the resulting structure with the aerosol method. As used herein, the term “anodic bonding” refers to a process whereby silicon and glass containing mobile ions internally are overlaid and heated, and direct current voltage is applied to the silicon side in the direction of positive electric potential to chemically bond the glass and silicon. Japanese Patent Application Publication No. 2002-36547 and other publications describe anodic bonding whereby a bonding plate having a piezoelectric element holder is bonded to the piezoelectric element on the flow channel formation plate, for example.

However, in the method whereby a flow channel plate is bonded and laminated using an adhesive, and a piezoelectric element is formed by an aerosol method on a separate plate (vibration plate or the like) devoid of adhesive, the piezoelectric element can be thinly formed over a large area, but there is no special advantage in terms of reliability. Furthermore, in the method whereby a pressure chamber is formed with a silicon wafer process without the use of an adhesive, the effects are adequate when a short head in involved, but there is a drawback in that when attempting to create a long head, the equipment for the wafer process becomes cumbersome and costs are increased.

In view of the above, manufacturing methods for a liquid discharge head have been proposed using a variety of techniques in which a piezoelectric element is formed by the aerosol method. Known examples include art in which the vibration plate and the pressure chambers are directly bonded without interposing an adhesive or the like, and the vibration plate is formed with a corrosion-resistant metallic oxide using the aerosol method (refer to Japanese Patent Application Publication No. 2003-136714, for example); and art in which the layers of a composite plate are directly bonded without the use of an adhesive, the vibration plate is composed of a piezoelectric material, and the product is formed by the aerosol method (refer to Japanese Patent Application Publication No. 2003-136715, for example).

Also known is art in which a vibration plate and a film serving as an electrode are laminated across the entire surface of the plate, a piezoelectric film is formed by the aerosol method using a resist pattern, the resist pattern is then removed, a pressure chamber is formed by etching the reverse side of the plate, and a nozzle plate is bonded thereto (refer to Japanese Patent Application Publication No. 2003-142750, for example); and art in which a piezoelectric body is formed on the vibration plate with the aerosol method (refer to Japanese Patent Application Publication No. 11-348297, for example).

Further known is art in which a piezoelectric element is formed with the aerosol method on a reaction inhibiting layer that inhibits reaction with lead atoms on a silicon substrate (refer to Japanese Patent Application Publication No. 2000-328223, for example); and additionally art in which piezoelectric elements are formed with the aerosol method on the vibration plate surface of the pressure chamber (refer to Japanese Patent Application Publication Nos. 8-267763 and 8-230181, for example).

However, as described above, conventional methods for forming a piezoelectric unit (piezoelectric element) on a vibration plate involve using a green sheet, polishing bulk materials, and other factors to form a flat lamination surface between the vibration plate and piezoelectric element, as shown in FIGS. 5 and 6, for example. Also, the bonding surface between the vibration plate and the piezoelectric body is also flat in the case of the discharge heads cited in the above patent references and other publications, even when forming a piezoelectric body (piezoelectric element) on a vibration plate with a conventional aerosol method.

When a piezoelectric body is formed with the aerosol method, the body is kept thin, and the displacement characteristics or generated pressure thereof are increased, then the actual magnitude of the deformation of the piezoelectric body varies depending on the location if the bonding surface thereof is flat, so these conditions cannot be handled, and there are drawbacks in terms of the piezoelectric strength, the strain applied to the piezoelectric element, and the like. In particular, when the film thickness of the piezoelectric body is kept low on the order of several micrometers, there is a drawback in that cracks easily are formed in the piezoelectric body, and the durability and reliability of the piezoelectric body is markedly reduced.

### SUMMARY OF THE INVENTION

The present invention was contrived in view of such circumstances, and an object thereof is to provide a liquid discharge head, manufacturing method thereof, and ink-jet recording apparatus that afford high durability and high reliability even when the piezoelectric element is made into a thin film and the density of the liquid discharge ports is increased.

The invention for achieving the above-stated object provides a manufacturing method for a droplet discharge head comprising the steps of: forming a pressure chamber by laminating a discharge port formation plate formed with discharge ports for discharging droplets, a flow channel formation plate for forming the partition walls of the pressure chamber for connecting to the discharge ports, and a vibration plate; forming a concavo-convex structure on the surface of the vibration plate; and forming a piezoelectric body by the aerosol method on the concavo-convex structure of the vibration plate surface, for generating pressure changes in the pressure chamber.

Thus, a concavo-convex structure is formed in the vibration plate surface, and a piezoelectric element is formed thereon with the aerosol method, so the thickness of the vibration plate that contributes to the deformation of the piezoelectric element varies by location, and the durability of the piezoelectric element actuator can be improved by changing the balance thereof.

The piezoelectric body is preferably formed with an inverted concavo-convex structure that corresponds to the concavo-convex structure of the vibration plate. The durability of the piezoelectric body actuator can be improved by increasing the thickness of the vibration plate in the portion in which the deformation of the piezoelectric body is great, and reducing the thickness of the vibration plate in portions in which the deformation of the piezoelectric body is small.

Bonding for laminating the discharge port formation plate, the flow channel formation plate, and the vibration plate, is preferably performed by glass deposition bonding or metal diffusion bonding. As a result, there is no need to consider the drawbacks that are commonly encountered when an adhesive is used, and the degree of freedom can be increased with respect to the ink that can be used in a droplet discharge head.

The invention for achieving the above-stated object in the same manner provides a droplet discharge head comprising: a pressure chamber formed by laminating a discharge port formation plate formed with discharge ports for discharging droplets, a flow channel formation plate for forming the partition walls of a pressure chamber that connects to the discharge ports, and a vibration plate whose surface is formed with the concavo-convex structure; and a piezoelectric body formed by the aerosol method on the concavo-convex structure of the surface of the vibration plate, for generating pressure changes within the pressure chamber. The durability of the piezoelectric body actuator can thereby be improved.

The invention for achieving the above-stated object in the same manner provides an inkjet recording apparatus including a droplet discharge head comprising: a pressure chamber formed by laminating a discharge port formation plate forming with discharge ports for discharging droplets, a flow channel formation plate forming the partition walls of the pressure chamber that connects to the discharge ports, and a vibration plate whose surface is formed with the concavo-convex structure; and a piezoelectric body formed by the aerosol method on the concavo-convex structure of the surface of the vibration plate, for generating pressure changes within the pressure chamber. The durability of the piezoelectric body actuator is thereby improved, and the reliability of the inkjet recording apparatus also can be improved.

As described above, in the liquid discharge head, manufacturing method thereof, and inkjet recording apparatus related to the present invention, durability and reliability can be improved even when the piezoelectric body has been made thin and the density of the liquid discharge ports has been increased.

### BRIEF DESCRIPTION OF THE DRAWINGS

FIG. 1 is an overall block diagram showing a schematic of an inkjet recording apparatus related to the present invention;

FIG. 2 is a cross-sectional diagram showing the schematic configuration of an ink-jet recording head as an embodiment of the droplet discharge head related to the present invention;

FIGS. 3A and 3B are cross-sectional diagrams showing enlarged views of the vibration plate and piezoelectric element formed in the present embodiment, wherein FIG. 3A shows the case in which the center of the piezoelectric element is thick, and FIG. 3B shows the case in which the center of the piezoelectric element is thin;

FIG. 4 is diagram showing the state of stress during deformation of the piezoelectric element formed in the present embodiment;

FIG. 5 is a cross-sectional diagram showing a schematic of a conventional liquid discharge head formed with laminated plates; and

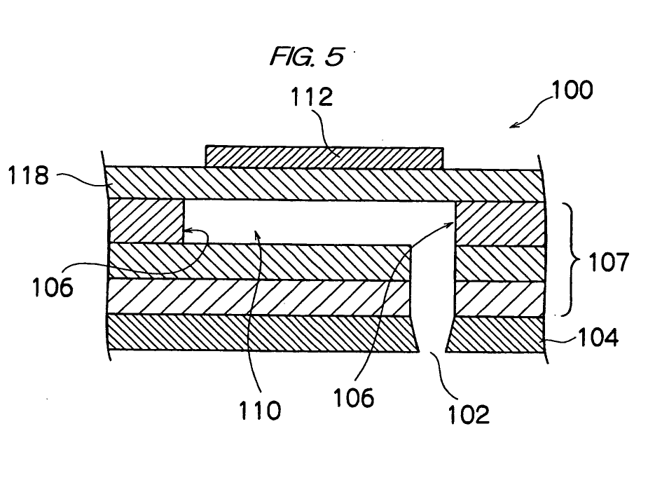

FIG. 6 is a cross-sectional diagram showing a schematic of a conventional liquid discharge head formed by a silicon process.

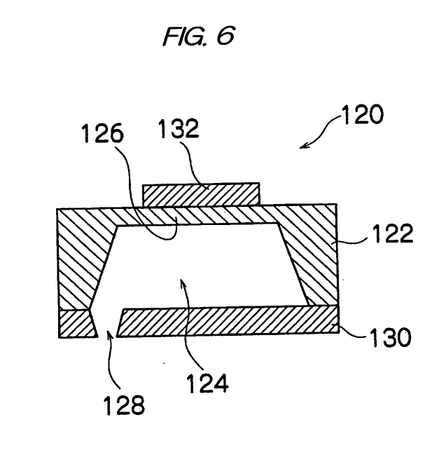

### DETAILED DESCRIPTION OF THE PREFERRED EMBODIMENTS

Below, with reference to the accompanying drawings, a liquid discharge head, manufacturing method thereof, and inkjet recording apparatus of the present invention is described in detail.

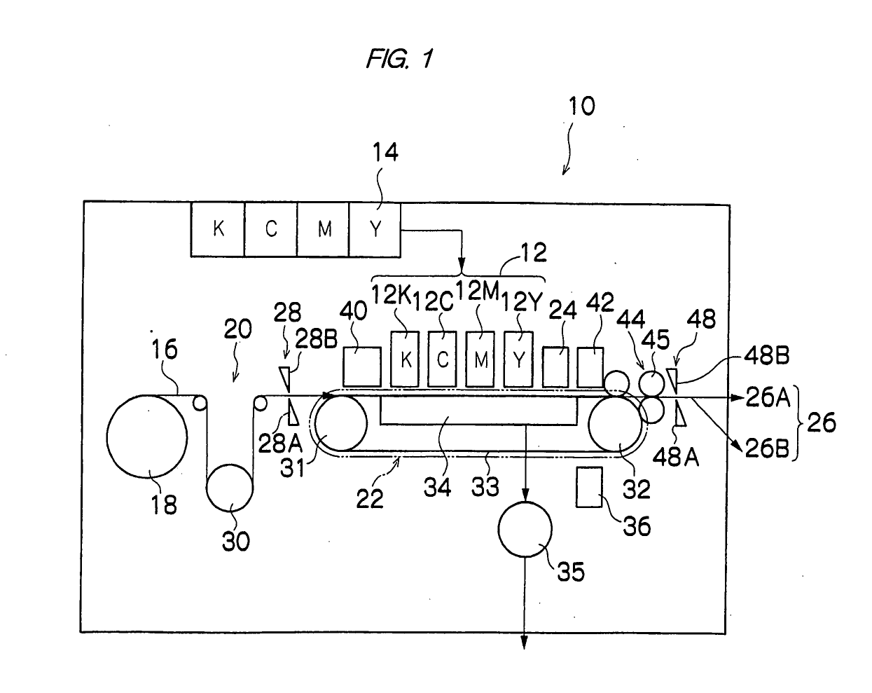

FIG. 1 is a general schematic drawing of an inkjet recording apparatus according to an embodiment of the present invention. As shown in FIG. 1, the inkjet recording apparatus 10 comprises: a printing unit 12 having a plurality of inkjet recording heads (hereinafter referred to as head) 12K, 12C, 12M, and 12Y for ink colors of black (K), cyan (C), magenta (M), and yellow (Y), respectively; an ink storing/loading unit 14 for storing inks to be supplied to those heads 12K, 12C, 12M, and 12Y; a paper supply unit 18 for supplying recording paper 16; a decurling unit 20 for removing curl in the recording paper 16; a suction belt conveyance unit 22 disposed facing the nozzle face (ink-droplet ejection face) of the print unit 12, for conveying the recording paper 16 while keeping the recording paper 16 flat; a print determination unit 24 for reading the printed result produced by the printing unit 12; and a paper output unit 26 for outputting image-printed recording paper (printed matter) to the exterior.

In FIG. 1, a single magazine for rolled paper (continuous paper) is shown as an example of the paper supply unit 18; however, a plurality of magazines with paper differences such as paper width and quality may be jointly provided. Moreover, paper may be supplied with a cassette that contains cut paper loaded i0n layers and that is used jointly or in lieu of a magazine for rolled paper.

In the case of the configuration in which roll paper is used, a cutter (first cutter) 28 is provided as shown in FIG. 1, and the continuous paper is cut into a desired size by the cutter 28. The cutter 28 has a stationary blade 28A, whose length is equal to or greater than the width of the conveyor pathway of the recording paper 16, and a round blade 28B, which moves along the stationary blade 28A. The stationary blade 28A is disposed on the reverse side of the printed surface of the recording paper 16, and the round blade 28B is disposed on the printed surface side across the conveyor pathway. When cut paper is used, the cutter 28 is not required.

In the case of a configuration in which a plurality of types of recording paper can be used, it is preferable that a information recording medium such as a bar code and a wireless tag containing information about the type of paper is attached to the magazine, and by reading the information contained in the information recording medium with a predetermined reading device, the type of paper to be used is automatically determined, and ink-droplet ejection is controlled so that the ink-droplets are ejected in an appropriate manner in accordance with the type of paper.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine. The heating temperature at this time is preferably controlled so that the recording paper 16 has a curl in which the surface on which the print is to be made is slightly round outward.

The decurled and cut recording paper 16 is delivered to the suction belt conveyance unit 22. The suction belt conveyance unit 22 has a configuration in which an endless belt 33 is set around rollers 31 and 32 so that the portion of the endless belt 33 facing at least the nozzle face of the printing unit 12 and the sensor face of the print determination unit 24 forms a horizontal plane (flat plane).

The belt 33 has a width that is greater than the width of the recording paper 16, and a plurality of suction apertures (not depicted) are formed on the belt surface. A suction chamber 34 is disposed in a position facing the sensor surface of the print determination unit 24 and the nozzle surface of the printing unit 12 on the interior side of the belt 33, which is set around the rollers 31 and 32, as shown in FIG. 1; and the suction chamber 34 provides suction with a fan 35 to generate a negative pressure, and the recording paper 16 is held on the belt 33 by suction.

The belt 33 is driven in the clockwise direction in FIG. 1 by the motive force of a motor (not depicted) being transmitted to at least one of the rollers 31 and 32, which the belt 33 is set around, and the recording paper 16 held on the belt 33 is conveyed from left to right in FIG. 1.

Since ink adheres to the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not depicted, examples thereof include a configuration in which the belt 33 is nipped with a cleaning roller such as a brush roller and a water absorbent roller, an air blow configuration in which clean air is blown onto the belt 33, or a combination of these. In the case of the configuration in which the belt 33 is nipped with the cleaning roller, it is preferable to make the line velocity of the cleaning roller different than that of the belt 33 to improve the cleaning effect.

The inkjet recording apparatus 10 can comprise a roller nip conveyance mechanism, in which the recording paper 16 is pinched and conveyed with nip rollers, instead of the suction belt conveyance unit 22. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 40 is disposed on the upstream side of the printing unit 12 in the conveyance pathway formed by the suction belt conveyance unit 22. The heating fan 40 blows heated air onto the recording paper 16 to heat the recording paper 16 immediately before printing so that the ink deposited on the recording paper 16 dries more easily.

The printing unit 12 forms a so-called full-line head in which a line head having a length that corresponds to the maximum paper width is disposed in the paper conveyance direction (sub-scanning direction) and in perpendicular direction to the paper conveyance (main scanning direction). Each of the print heads 12K, 12C, 12M, and 12Y is composed of a line head, in which a plurality of ink-droplet ejection apertures (nozzles) are arranged along a length that exceeds at least one side of the maximum-size recording paper 16 intended for use in the inkjet recording apparatus 10.

Each of the print heads 12K, 12C, 12M, and 12Y are arranged in order of black (K), cyan (C), magenta (M), and yellow (Y) from the upstream side along the paper conveyance direction, is composed of a line head, in which a plurality of ink-droplet ejection apertures (nozzles) are arranged along a length that exceeds at least one side of the maximum-size recording paper 16 intended for use in the inkjet recording apparatus 10.

A color print can be formed on the recording paper 16 by ejecting the inks from those heads 12K, 12C, 12M, and 12Y, respectively, onto the recording paper 16 while conveying the recording paper 16 with the belt 33.

Thus, with the recording unit 12 in which full-line heads that cover the entire width of the paper are provided for each ink color, an image can be recorded across the entire surface of the recording paper 16 by performing the action of moving the recording paper 16 and recording unit 12 in relation to each other as the sub-scanning direction in the paper conveyance direction just once (i.e., with a single scanning). High-speed recording is thereby made possible in comparison with a shuttle type head in which the print head reciprocates in the main scanning direction of the recording head, and productivity can be improved.

Although the configuration with the KCMY four standard colors is described in the present embodiment, combinations of the ink colors and the number of colors are not limited to those, and light and/or dark inks can be added as required. For example, a configuration is possible in which inkjet recording heads for ejecting light-colored inks such as light cyan and light magenta are added.

As shown in FIG. 1, the print determination unit 24 has an image sensor for capturing an image of the ink-droplet deposition result of the print unit 12, and functions as a device to check for ejection defects such as clogs of the nozzles in the print unit 12 from the ink-droplet deposition results evaluated by the image sensor. The ink storing/loading unit 14 has a warning device (e.g., a display device, an alarm sound generator) for warning when the remaining amount of any ink is low, and has a mechanism for preventing loading errors among the colors.

The print determination unit 24 has an image sensor for capturing an image of the ink-droplet deposition result of the print unit 12, and functions as a device to check for ejection defects such as clogs of the nozzles in the print unit 12 from the ink-droplet deposition results evaluated by the image sensor.

The print determination unit 24 of the present embodiment is configured with at least a line sensor having rows of photoelectric transducing elements with a width that is greater than the ink-droplet ejection width (image recording width) of those heads 12K, 12C, 12M, and 12Y. This line sensor has a color separation line CCD sensor including a red (R) sensor row composed of photoelectric transducing elements (pixels) arranged in a line provided with an R filter, a green (G) sensor row with a G filter, and a blue (B) sensor row with a B filter. Instead of a line sensor, it is possible to use an area sensor composed of photoelectric transducing elements which are arranged two-dimensionally.

The print determination unit 24 reads a test pattern printed with those heads 12K, 12C, 12M, and 12Y for the respective colors, and the ejection of each head is determined. The ejection determination includes the presence of the ejection, measurement of the dot size, and measurement of the dot deposition position.

A post-drying unit 42 is disposed following the print determination unit 24. The post-drying unit 42 is a device to dry the printed image surface, and includes a heating fan, for example. It is preferable to avoid contact with the printed surface until the printed ink dries, and a device that blows heated air onto the printed surface is preferable.

In cases in which printing is performed with dye-based ink on porous paper, blocking the pores of the paper by the application of pressure prevents the ink from coming contact with ozone and other substance that cause dye molecules to break down, and has the effect of increasing the durability of the print.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are preferably outputted separately. In the inkjet recording apparatus 10, a sorting device (not depicted) is provided for switching the outputting pathway in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48. The cutter 48 is disposed directly in front of the paper output unit 26, and is used for cutting the test print portion from the target print portion when a test print has been performed in the blank portion of the target print. The structure of the cutter 248 is the same as the first cutter 28 described above, and has a stationary blade 48A and a round blade 48B.

Next, the structure of the print heads is described. The print heads 12K, 12C, 12M, and 12Y provided for the ink colors have the same structure, and a reference numeral 50 is hereinafter designated to any of the print heads 12K, 12C, 12M, and 12Y.

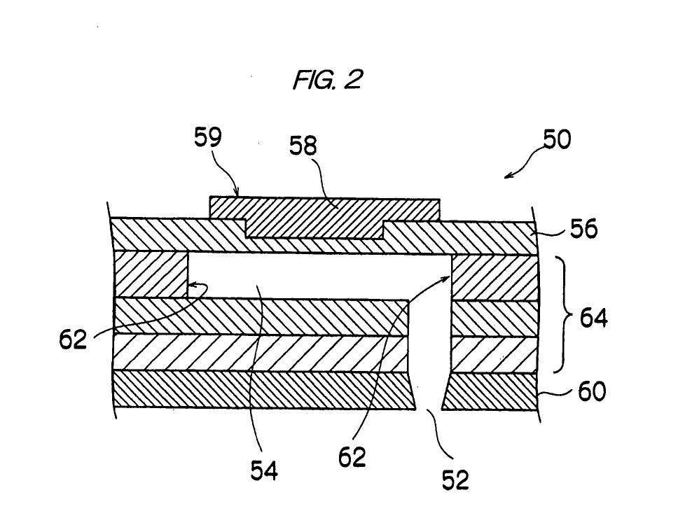

FIG. 2 is a cross-sectional diagram showing the schematic configuration of a print head (inkjet head) as an embodiment of the droplet discharge head related to the present invention. As shown in FIG. 2, the print head 50 (inkjet head) of the present embodiment is composed of a nozzle (droplet discharge port) 52 for discharging ink (liquid) as ink droplets (droplets); a pressure chamber 54 connected to this nozzle 52 and designed to apply pressure in order to discharge ink; a vibration plate 56 that seals one face (upper surface in the diagram) of the pressure chamber 54 and constitutes a portion of the pressure chamber 54; and a piezoelectric element (piezoelectric body) 58 formed on the upper portion of the vibration plate 56. Although omitted from the diagram, an ink supply flow channel and an ink supply port for supplying ink are provided in communication with the pressure chamber 54.

Also, a plurality of nozzles 52, pressure chambers 54, and the like such as those shown in the diagram are arrayed in the direction perpendicular to the surface of the paper of FIG. 2; and each ink supply port is connected to the common liquid chamber (also omitted from the diagram) and is configured to receive a supply of ink from the common liquid chamber.

Although this is not depicted in the diagrams, electrodes (top electrode and bottom electrode) are thinly formed on the top and bottom surfaces of the piezoelectric element 58. By applying voltage to the electrodes formed on the top and bottom surfaces of the piezoelectric element 58 during ink discharge, the piezoelectric element 58 deforms and the center of the vibration plate 56 operates so as to flex toward the pressure chamber 54. By volume displacement due to the bending deformation of the piezoelectric element 58 and the vibration plate 56, ink in the pressure chamber 54 is compressed and is discharged from the nozzle 52 connected to the pressure chamber 54 as an ink droplet.

When the voltage applied to the piezoelectric element 58 is returned to its original level, the piezoelectric element 58 and vibration plate 56 return to their original states, and ink is supplied from the common liquid chamber to the pressure chamber 54 by way of an ink supply port (not depicted).

The nozzle 52 is formed on the nozzle plate (discharge port formation plate) 60, the partition walls 62 of the pressure chamber 54 are formed by the flow channel plate (flow channel formation plate) 64, and the pressure chamber 54 is formed by laminating the nozzle plate 60, flow channel plate 64, and vibration plate 56.

The manufacturing method for the print head (inkjet head) 50 is described below.

First, each plate is composed of metal, and holes or other shapes are processed thereto. The portion of the nozzle plate 60 that is to serve as the nozzle 52 is punched out, as are the portions of the flow channel plate 64 that are to serve as the partition walls 62 of the pressure chamber 54 and the portion that is to serve as the connection hole to the nozzle 52. A predetermined concavo-convex structure is formed on the vibration plate 56. This concavo-convex structure is formed so that the stepped portion is 1/10 or more of the thickness of the vibration plate 56. The shape of the concavo-convex structure is not particularly limited, but should be designed with consideration for the type of head that is to be fabricated. An electrode is formed on the vibration plate 56 by sputtering, coating, printing, or another method, for example.

Next, the nozzle plate 60, flow channel plate 64, and vibration plate 56 are bonded by glass deposition bonding or metal diffusion bonding, and each plate is laminated to form the pressure chamber 54. When using glass deposition, a glass film for glass deposition is formed on each of the plate surfaces, these are overlaid and heated in a furnace or the like, the glass is melted, and pressure is applied thereto to bond the melted glass together.

When using metal diffusion bonding, oil and the like adhering to the surface of each of the metal plates is removed by cleaning, the plates are overlaid and pressure is applied while the furnace is in a high-temperature, high-pressure state, and the connection portion of each plate is alloyed to reliably complete the bonding.

Thus, in the present embodiment, tight bonding is achieved by the molecular binding of the glass or metal, and no adhesive is used, so there are no collateral drawbacks such as those encountered when adhesive is used in that the protruding adhesive does not intervene and obstruct the ink flow channel, each plate can be reliably bonded, and the degree of freedom in the terms of the ink that can be used can be increased without chemical reaction between the ink and the adhesive or other constraints.

Next, a piezoelectric element 58 is formed with the aerosol method on the vibration plate 56 that forms the top surface of the pressure chamber 54 thus formed. Using a mask applied to this structure in a manner such that solely the portion of the pressure chamber 54 of the vibration plate 56 is exposed, the piezoelectric element 58 is formed by spraying and depositing fine particles of PZT (lead zirconate titanate Pb(Zr, Ti)O3) in an ultrafine particulate state at high speed through a spray nozzle together with a carrier gas onto the surface of the vibration plate 56, and forming a film with heating treatment.

At this time, the surface 59 of the piezoelectric element 58 is flattened. Ultimately, the piezoelectric element 58 is thinly formed on the thick portion of the vibration plate 56, and the piezoelectric element 58 is thickly formed on the thin portion of the vibration plate 56, as shown in FIG. 2. The piezoelectric element 58 is thereby formed such that an inverse concavo-convex structure is formed in relation to that of the concavo-convex structure on the vibration plate 56.

After the piezoelectric element 58 is formed, the inkjet head 50 is fabricated by removing the mask. In the present embodiment, the flow channel plate 64 and other plates are thus bonded and laminated with glass deposition bonding, metal diffusion bonding, or another bonding method that does not use an adhesive, so the piezoelectric element 58 can thereafter be formed with the aerosol method on the vibration plate 56.

The plates are laminated in this manner and the piezoelectric element 58 is thereafter formed by the aerosol method, so the plates can be reliably pressed during laminating and bonding. Also, the piezoelectric element 58 is formed with the aerosol method, so it is not necessary to apply pressure to a separately fabricated thin piezoelectric element 58 to ensure bonding with the vibration plate 56, and there is no danger that the piezoelectric element 58 will crack due to the application of pressure during bonding.

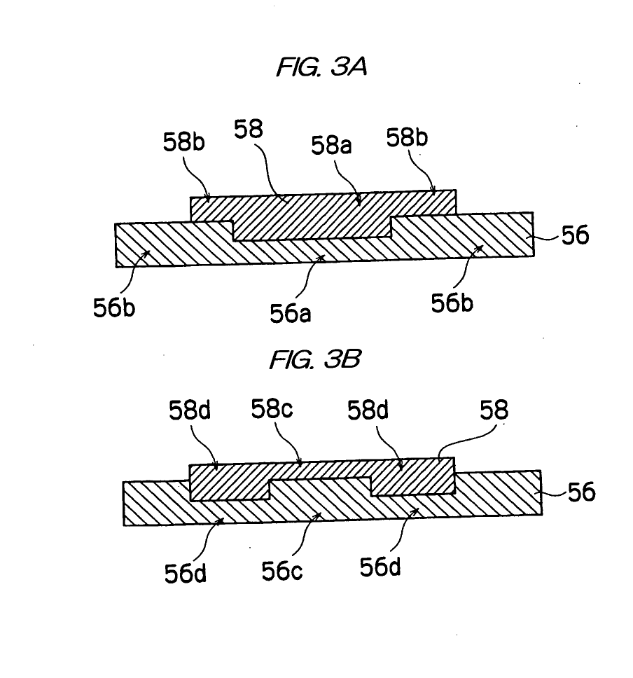

The area containing the vibration plate 56 and piezoelectric element 58 formed in this manner is shown enlarged in FIGS. 3A and 3B. In the case of FIG. 3A, the vibration plate 56 has a concavo-convex structure whose center portion 56a is thin and the two edge portions 56b are thick, and, conversely, the piezoelectric element 58 has an inverse concavo-convex structure in relation to that of the vibration plate 56, with the center portion 58a made thick and the edge portions 58b thin.

In the example shown in FIG. 3B, the vibration plate 56 has a concavo-convex structure whose center portion 56c is thick and the two edge portions 56d are thin, and, conversely, the piezoelectric element 58 has an inverse concavo-convex structure in relation to that of the vibration plate 56, with the center portion 58c made thin and the two edge portions 58d thick.

The piezoelectric element 58 is configured that strain to contribute toward in-plane deformation is large in the thin portion, and is low in the thick portion. The vibration plate 56 can be easily deformed within the plane in the thin portion, and is deformed with greater difficulty the thick portion.

In view of the above, a concavo-convex structure is formed on the vibration plate 56 in this manner in the present embodiment, and a piezoelectric element 58 is correspondingly formed in correlation thereto, so improvement in the durability of the piezoelectric body actuator can be ensured by varying the balance between the thicknesses of the vibration plate 56 and the thickness of the piezoelectric element 58, which contribute to the deformation of the piezoelectric element 58 and vibration plate 56.

For example, the portion in which the rigidity of the vibration plate 56 is low is disposed in correspondence with the portion in which strain of the piezoelectric element 58 is to be prevented, and the portion in which the amount of deformation of the piezoelectric element 58 is large is disposed in correspondence with the other portions.

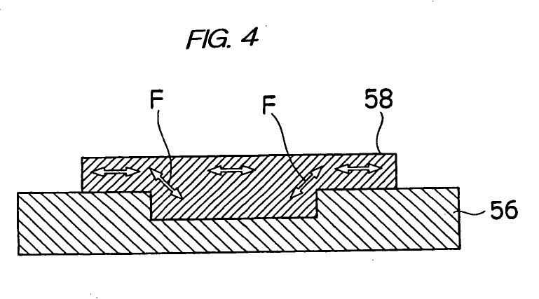

FIG. 4 shows the state of stress during deformation of the piezoelectric element formed in the present embodiment. When voltage is applied to the piezoelectric element 58 during ink discharge, stress is exerted in the directions shown by the arrows in FIG. 4 inside the piezoelectric element 58. At this time, the equipotential surface in the stepped portion (angled portion) of the concavo-convex structure is diagonal, and the vertical component of the force produced by the strain of the piezoelectric element 58 generated on this diagonal indicated by arrows F in the diagram is exerted directly in the direction perpendicular to the bottom surface of the vibration plate 56, as shown in FIG. 4, so the fast responsiveness of the deformation is improved.

In accordance with the present embodiment as described above, the vibration plate is provided with a concavo-convex structure, so the bottom electrode surface also has a concavo-convex surface. The piezoelectric element is formed with the aerosol method on the vibration plate having the concavo-convex surface, so the piezoelectric element (and the bottom electrode) can be formed tightly on the surface of the vibration plate with the concavo-convex surface. In this case, the equipotential surface of the bottom electrode side of the piezoelectric element is no longer flat.

The concavo-convex structure is formed on the vibration plate as described above, so the rigidity of the vibration plate can be made nonuniformity. For example, the rigidity of the center portion of the vibration plate can be reduced, as shown in FIG. 3A. The rigidity of the vibration plate and the voltage applied to the piezoelectric element can thereby be designed to increase the displacement and pressure of the piezoelectric element, and to reduce the strain of the piezoelectric element.

As a result, high durability and high reliability can be obtained even when the piezoelectric element is made thinner and the density of the recording head is increased. Furthermore, because of the formation of a concavo-convex structure, the fast responsiveness of the piezoelectric body actuator can be improved by the vertical component of the force diagonally generated in the angled portion of the corrugation.

A liquid discharge head, manufacturing method thereof, and inkjet recording apparatus related to the present invention were described above in detail, but the present invention is not limited to the above examples, the concavo-convex structure may be modified, and a plurality of steps and curvature may naturally be provided within the scope that does not depart from the spirit of the present invention.

1. A manufacturing method for a droplet discharge head comprising the steps of:
forming a pressure chamber by laminating a discharge port formation plate formed with discharge ports for discharging droplets, a flow channel formation plate for forming the partition walls of the pressure chamber for connecting to the discharge ports, and a vibration plate;
forming a concavo-convex structure on the surface of the vibration plate; and
forming a piezoelectric body by the aerosol method on the concavo-convex structure of the vibration plate surface, for generating pressure changes in the pressure chamber.

2. The manufacturing method for a droplet discharge head according to claim 1, wherein the piezoelectric body is formed with an inverted concavo-convex structure that corresponds to the concavo-convex structure of the vibration plate.

3. The manufacturing method for a droplet discharge head according to claim 1, wherein bonding for laminating the discharge port formation plate, the flow channel formation plate, and the vibration plate, is performed by glass deposition bonding or metal diffusion bonding.

4. The manufacturing method for a droplet discharge head according to claim 2, wherein bonding for laminating the discharge port formation plate, the flow channel formation plate, and the vibration plate, is performed by glass deposition bonding or metal diffusion bonding.

5. A droplet discharge head comprising:
a pressure chamber formed by laminating a discharge port formation plate formed with discharge ports for discharging droplets, a flow channel formation plate for forming the partition walls of a pressure chamber that connects to the discharge ports, and a vibration plate whose surface is formed with the concavo-convex structure; and
a piezoelectric body formed by the aerosol method on the concavo-convex structure of the surface of the vibration plate, for generating pressure changes within the pressure chamber.

6. An inkjet recording apparatus including a droplet discharge head comprising:
a pressure chamber formed by laminating a discharge port formation plate forming with discharge ports for discharging droplets, a flow channel formation plate forming the partition walls of the pressure chamber that connects to the discharge ports, and a vibration plate whose surface is formed with the concavo-convex structure; and
a piezoelectric body formed by the aerosol method on the concavo-convex structure of the surface of the vibration plate, for generating pressure changes within the pressure chamber.
